(19) United States
(12) Patent Application Publication
(10) Pub. No.: US 2012/0225155 A1
(43) Pub. Date: Sep. 6, 2012

(54) MACHINE FOR MANUFACTURING HOLLOW ELASTIC BALL

(76) Inventors: Chia-Yen Lin, Dongguan City (CN); Tsui-Mei Weng, Dongguan City (CN)

(21) Appl. No.: 13/038,380

(22) Filed: Mar. 1, 2011

(51) Int. Cl. B28B 7/08

(52) U.S. Cl. 425/453

(57) ABSTRACT

A machine for manufacturing a hollow elastic ball includes a base, an X-direction driving device, a Y-direction driving device and a molding device. The X-direction driving device is installed on the base; an outer frame is driven by an X-direction motor to rotate about an X-direction rotation shaft. The Y-direction driving device is installed on the outer frame; a Y-direction motor fastened on the outer frame drives an inner frame to rotate about a Y-direction rotation shaft. The molding device includes a carrying plate fastened in the inner frame and a mold fastened with the carrying plate. When the mold is filled with liquid material, the outer frame and the inner frame simultaneously rotate about the X-direction rotation shaft and the Y-direction rotation shaft, such that the material is uniformly distributed over the inner wall of the mold so as to form a hollow elastic ball.

### BACKGROUND OF THE INVENTION

1. Field of the Invention

The present invention relates to a machine for manufacturing a hollow elastic ball.

2. The Prior Arts

The most common elastic ball, such as a basketball and a football, is made of a layer of rubber or leather creating a hollow chamber and inflated with air. For the inflated hollow ball, the pressurized air in the ball makes the ball bounce. Another type of elastic ball is a solid ball made of polyurethane (PU material). The bounce characteristics of the ball come from the polyurethane itself. Still another type of elastic ball is a hollow ball made of PU material and the hollow center thereof may be filled with fluid or ornaments. Moreover, the inner wall of the ball may be painted for decoration.

The PU material is formed through polymerization by reacting at least two liquid components in a certain ratio. After mixing the liquid components, a chemical reaction takes place and the mixed liquid gradually solidifies. One of the methods for manufacturing a hollow elastic ball is applying the mixed liquid PU material in a rotating spherical mold and the PU material being coated and solidified on the inner surface of the mold to form a hollow ball. A small opening is formed on the ball skin by a protruded needle on the mold, so air can be pumped into the hollow chamber of the ball. Then, a sealing plug is inserted in the opening for sealing. During the solidifying process, the mold has to be continuously rotated by labor in order to create even ball wall thickness. Because every worker rotates mold differently, it is hard to have uniformed ball thickness. And because it takes time for the PU material to solidify, the yield of ball depends on how many workers can hold and rotate the ball mold.

### SUMMARY OF THE INVENTION

A primary objective of the present invention is to provide a machine capable of mass production of hollow elastic balls with stable quality.

Another objective of the present invention is to provide a machine for manufacturing a hollow elastic ball in which a mold is simultaneously rotated about two axes. Because of the simultaneous two-axial rotation, the PU material contained in the mold can be uniformly coated over the inner surface of ball mold and a hollow elastic ball is made without manual operation.

Still another objective of the present invention is to provide an electrical connection structure that can constantly supply power to a driving device serving for driving a mold to simultaneously rotate about two axes.

Further still another objective of the present invention is to provide a molding device, which is capable of rapidly installing a mold to or dismantling a mold from a machine for manufacturing a ball, and capable of rapidly replacing a carrying plate for holding the mold according to the sizes of the balls.

In order to achieve the objectives, a machine for manufacturing a hollow elastic ball according to the present invention comprises a base, an X-direction driving device, a Y-direction driving device and a molding device. The X-direction driving device is mounted on the base. An X-direction motor drives an outer frame to rotate about an X-direction rotation shaft. The Y-direction driving device is mounted on the outer frame. An inner frame is moveably installed within the outer frame and driven by a Y-direction motor mounted on the outer frame to rotate about a Y-direction rotation shaft. The molding device includes a carrying plate installed on the inner frame and a mold fastened on the carrying plate. When the mold is filled with liquid chemicals and is disposed on the carrying plate, the outer frame and the inner frame is rotated about the X-direction and Y-direction, respectively. Therefore, rotation of the mold takes place simultaneously about two axes and the mixed PU is uniformly coated on an inner wall of the mold for forming a hollow elastic ball.

According to the present invention, the X-direction motor may directly drive the X-direction rotation shaft of the outer frame to rotate or indirectly drive the X-direction rotation shaft to rotate through an X-direction transmission mechanism. According to an embodiment of the present invention, the X-direction transmission mechanism includes an X-direction active pulley connecting with the X-direction motor, an X-direction passive pulley connecting with the X-direction rotation shaft and a belt connecting the X-direction active pulley and the X-direction passive pulley. Similarly, the X-direction transmission mechanism according to another embodiment includes two sprockets and a chain. According to still another embodiment, the X-direction transmission mechanism includes an X-direction active gear connecting with the X-direction motor and an X-direction passive gear connecting with the X-direction rotation shaft. The X-direction active gear is engaged with the X-direction passive gear. Therefore, the X-direction motor can drive the outer frame to rotate about the X-direction rotation shaft.

Similar to the X-direction driving device, the Y-direction motor may directly drive the Y-direction rotation shaft of the inner frame to rotate or indirectly drive the Y-direction rotation shaft to rotate through a Y-direction transmission mechanism. The Y-direction transmission mechanism may includes two pulleys and a belt, two sprockets and a chain or two gears engaged with each other. Therefore, the Y-direction motor can drive the inner frame to rotate about the Y-direction rotation shaft.

According to an embodiment, a power controller and an X-direction motor speed governor is installed on the base and a Y-direction motor speed governor is installed on the outer frame. The power controller is electrically connected to both of the X-direction motor speed governor and the Y-direction motor speed governor. The X-direction motor speed governor and the Y-direction motor speed governor are electrically connected to the X-direction motor and the Y-direction motor, respectively. The power controller supplies electricity to the motor speed governors. Then operations and rotation speeds of the X-direction motor and the Y-direction motor are controlled by the X-direction motor speed governor and the Y-direction motor speed governor, respectively. Because the outer frame and the inner frame are simultaneously rotated and wires are electrically connected to the Y-direction motor speed governor mounted at the outer frame, the wires would wind around the frames and eventually cause stop. In order to solve the problem, the electrical connection structure between the power controller and the Y-direction motor speed governor provides a first conduction piece and a second conduction piece mounted on the X-direction rotation shaft. The first conduction piece and the second conduction piece are insulating to each other and rotating with the X-direction rotation shaft. The Y-direction motor speed governor is electrically connected to the first conduction piece and the second conduction piece by a first conduction wire and a second conduction wire, respectively. The power controller is connected to a first conduction strip and a second conduction strip by a first power wire and a second power wire, respectively. Then the first conduction strip and the second conduction strip are electrically contacted with the first conduction piece and the second conduction piece, respectively.

The molding device according to the present invention device includes supporting racks installed at two symmetrical ends of the inner frame, a carrying plate installed on the two supporting racks, and a mold installed on the carrying plate. The carrying plate has a central hole for allowing the mold to be disposed therein and the carrying plate can include magnets. When the mold is disposed in the central hole, metal buckling units installed on the mold are attracted by the magnets, thereby fixing the mold onto the carrying plate. The magnets are especially suitable to fix the mold for a smaller ball onto the carrying plate.

According to an embodiment, the present invention may further include a rotation device. The rotation device includes a rotatable annular carrier and a plurality of the machines for manufacturing the hollow elastic ball is installed on the annular carrier. The rotation device may also include a plurality of the annular carriers which are vertically arranged to form a multi-layer structure. The rotation speed of the annular carrier can be adjusted depending on the solidifying rate of the mixed PU material in the mold. Therefore, when the mold disposed on the annular carrier is conveyed from a first location to a second location, the PU material is solidified and the ball member is ready to be removed from the mold. Thus, labor cost is reduced.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic plane front view of a machine for manufacturing a hollow elastic ball according to an embodiment of the present invention;

FIG. 2 is a schematic top view of FIG. 1;

FIG. 3 is a schematic top view illustrating an outer frame and an inner frame being driven to rotate;

FIG. 4 is an exploded view illustrating a molding device according to the present invention;

FIG. 5 is a perspective view illustrating the molding device according to the present invention;

FIG. 6 is a cross sectional view showing PU material contained in a mold of the molding device according to the present invention;

FIG. 7 is a schematic view illustrating an electrical connection structure between a power controller and a Y-direction motor;

FIG. 8 is schematic view illustrating the outer frame and the inner frame according to the present invention simultaneously rotating about an X-axis and a Y-axis, respectively;

FIG. 9 is a schematic top view illustrating a rotation device having an annular carrier and a plurality of the machines for manufacturing the hollow elastic ball mounted on the annular carrier according to another embodiment of the present invention; and

FIG. 10 is a schematic side view illustrating the rotation device having a plurality of the annular carriers and the machines for manufacturing the hollow elastic ball mounted on the annular carriers according to still another embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

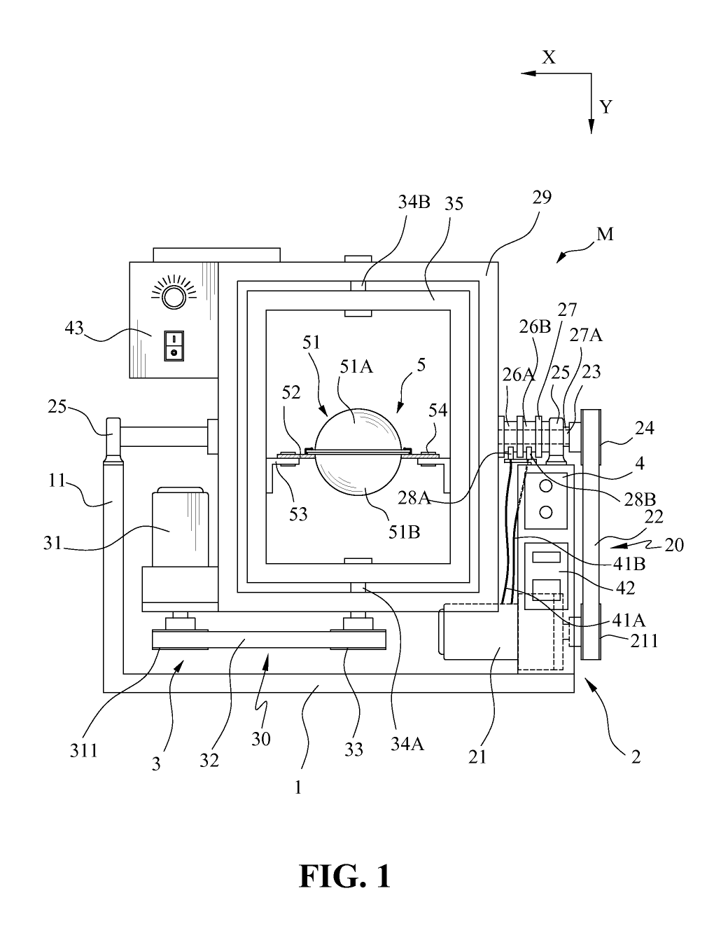

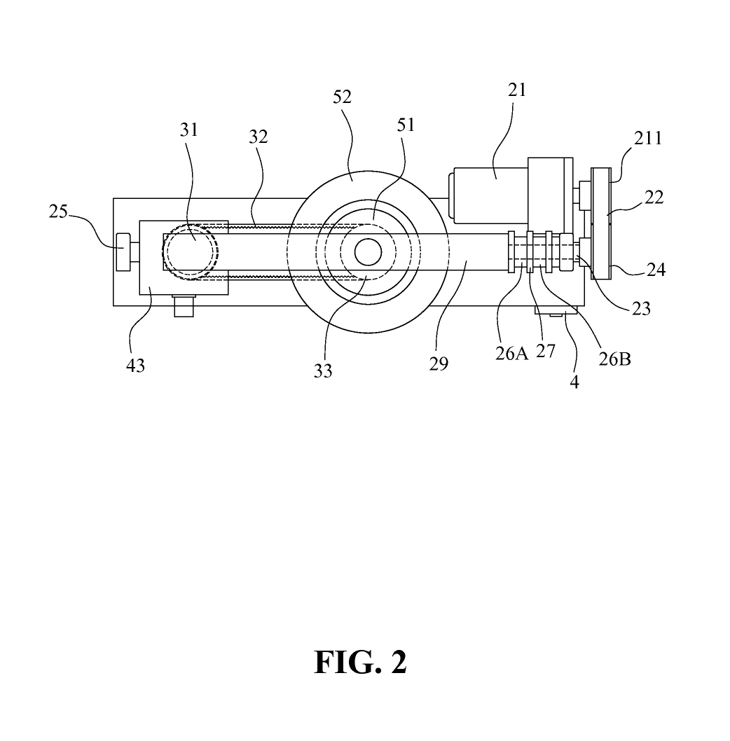

Referring to FIG. 1 and FIG. 2, a machine M for manufacturing a hollow elastic ball according to a preferred embodiment of the present invention includes a base 1, an X-direction driving device 2, a Y-direction driving device 3 and a molding device 5.

The base 1 is substantially in a U shape and includes lateral walls 11 at two opposite ends. The X-direction driving device 2 includes an outer frame 29. Two opposite outer sides of the outer frame 29 are respectively and coaxially provided with an X-direction rotation shaft 23. An insulation piece 27A is disposed on the outer surface of the X-direction rotation shaft 23. Each of the two X-direction rotation shafts 23 are connected with a bearing 25, which is installed at the lateral wall 11 of the base 1. Thus, the X-direction rotation shafts 23 are able to be freely rotated in the base 1, and the insulation piece 27A is simultaneously rotated with the X-direction rotation shafts 23. An X-direction motor 21 drives the X-direction rotation shafts 23 to rotate. The X-direction rotation shafts 23 may be directly driven by the X-direction motor 21 (not shown in drawings) or the X-direction rotation shafts 23 may be indirectly driven by the X-direction motor 21 through an X-direction transmission mechanism 20. The X-direction transmission mechanism 20 includes an X-direction active pulley 211, an X-direction passive pulley 24 and a belt 22. One of the X-direction rotation shafts 23 is connected with the X-direction passive pulley 24. The X-direction motor 21 is fixed on the base 1 and connected with the X-direction active pulley 211. The belt 22 connects the X-direction active pulley 211 with the X-direction passive pulley 24. Thus, when the X-direction motor 21 is activated, the X-direction motor 21 drives the X-direction active pulley 211 to rotate, the belt 22 drives the X-direction passive pulley 24 to rotate and the X-direction passive pulley 24 drives the X-direction rotation shafts 23 to rotate. Alternatively, the X-direction driving device 2 may use other transmission mechanisms other than the belt and pulleys. For example, sprockets and a chain or gears (not shown in drawings) may replace the belt and the pulleys. According to another embodiment, the X-direction transmission mechanism 20 includes an X-direction active gear connected with the X-direction motor 21 and an X-direction passive gear connected with the X-direction rotation shaft 23. The X-direction active gear is engaged with the X-direction passive gear. When the X-direction motor 21 is activated, the X-direction motor 21 drives the X-direction active gear to rotate, the X-direction active gear drives the X-direction passive gear to rotate and the X-direction passive gear drives the X-direction rotation shafts 23 to rotate. The outer frame 29 rotates with the X-direction rotation shafts 23 about an axis formed by the two X-direction rotation shafts 23. The Y-direction driving device 3 includes an inner frame 35 having Y-direction rotation shafts 34A, 34B at two opposite sides, and a Y-direction motor 31 fixed on the outer frame 29. The inner frame 35 is rotatably installed inside the outer frame 29 by the Y-direction rotation shafts 34A, 34B. The Y-direction motor 31 may directly drive the Y-direction rotation shaft 34A to rotate (not shown in drawings) or indirectly drive the Y-direction rotation shaft 34A to rotate by a Y-direction transmission mechanism 30. The Y-direction transmission mechanism 30 includes a Y-direction active pulley 311, a Y-direction passive pulley 33 and a belt 32. The Y-direction motor 31 and the Y-direction rotation shaft 34A are connected with the Y-direction active pulley 311 and the Y-direction passive pulley 33, respectively. The Y-direction active pulley 311 and the Y-direction passive pulley 33 are connected by the belt 32. Similarly, when the Y-direction motor 31 is operated, the inner frame 35 is driven to rotate as the Y-direction rotation shafts 34A, 34B serving as a rotation axis. Similar to the X-direction driving device 2, the Y-direction driving device 3 may use other transmission mechanisms, such as gears, sprockets/chain (not shown in drawings), etc., to replace the pulleys and the belt. For example, the Y-direction transmission mechanism 30 includes a Y-direction active gear connected with the Y-direction motor 31 and a Y-direction passive gear connected with the Y-direction rotation shafts 34A. The Y-direction active gear is engaged with the Y-direction passive gear. When the Y-direction motor 31 is activated, the Y-direction motor 31 drives the Y-direction active gear to rotate, the Y-direction active gear directly drives the Y-direction passive gear to rotate and the Y-direction passive gear drives the Y-direction rotation shafts to rotate.

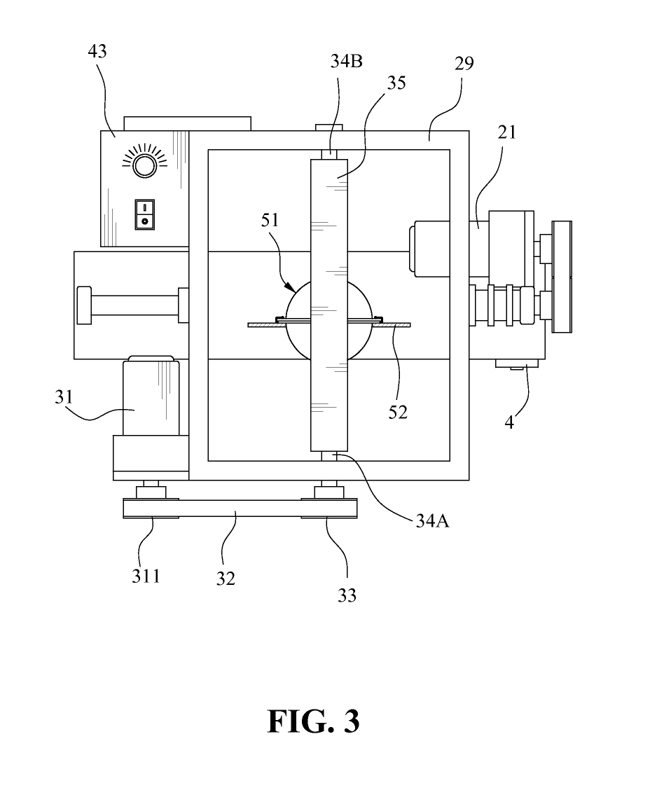

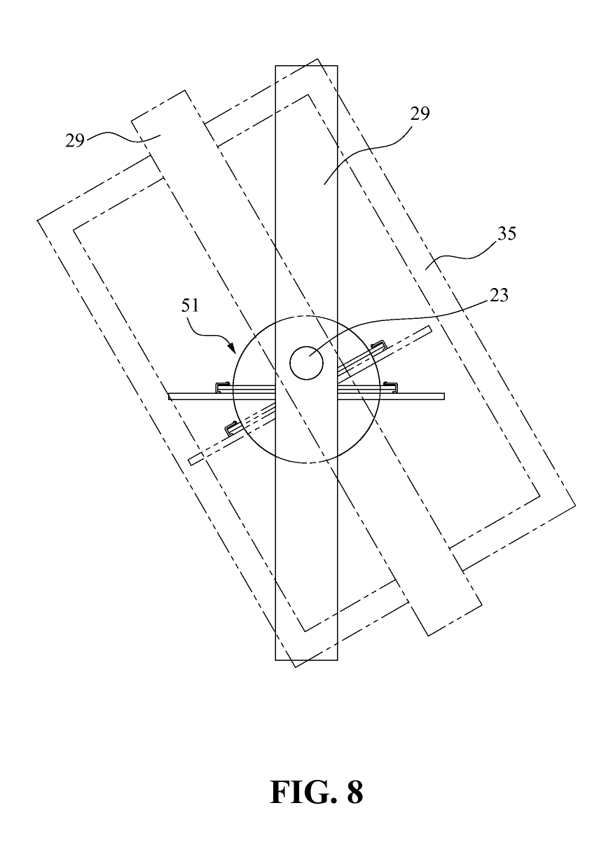

A power controller 4 and an X-direction motor speed governor 42 are mounted on the base 1, and a Y-direction motor speed governor 43 and the Y-direction motor 31 are mounted on the outer frame 29. The power controller 4 is electrically connected with the X-direction motor speed governor 42 and the X-direction motor speed governor 42 is electrically connected with the X-direction motor 21. Similarly, the power controller 4 is electrically connected with the Y-direction motor speed governor 43 and the Y-direction motor speed governor 43 is electrically connected with the Y-direction motor 31. The power controller 4 provides currents to the X-direction motor speed governor 42 and the Y-direction motor speed governor 43 so as to respectively control operations of the X-direction motor 21 and the Y-direction motor 31 for driving the outer frame 29 and the inner frame 35 to simultaneously rotate. The rotation states are shown in FIG. 3 and FIG. 8.

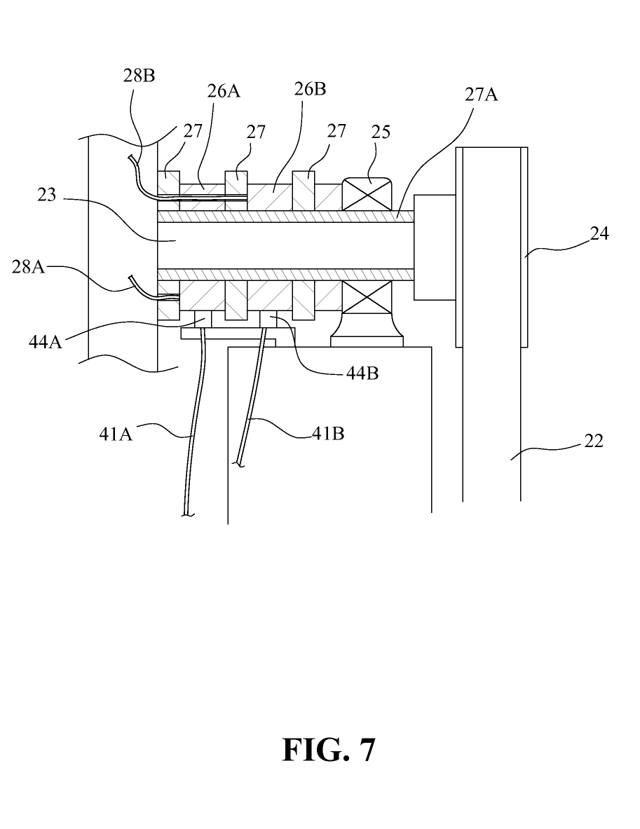

Referring to FIG. 7, the Y-direction motor speed governor 43 is fixed on and rotated with the outer frame 29, and the power controller 4 is mounted on the base 1. If the power controller 4 is directly and electrically connected with the Y-direction motor speed governor 43 by a power cable, the power cable would inevitably wind up or even cause damage due to the rotation of the outer frame 29. For keeping the continuous electrical connection between the power controller 4 and the Y-direction motor speed governor 43, the insulation piece 27A is connected with at least a first conduction piece 26A and a second conduction piece 26B. Insulation pieces 27 are disposed between the first conduction piece 26A and the second conduction piece 26B. The insulation pieces 27 also insulate the conduction pieces 26A, 26B from the outer frame 29 or other components. The first conduction piece 26A and the second conduction piece 26B rotate with the X-direction rotation shaft 23. The Y-direction motor speed governor 43 is electrically connected to a first conduction wire 28A and a second conduction wire 28B. The first conduction wire 28A and the second conduction wire 28B are electrically connected to the first conduction piece 26A and the second conduction piece 26B, respectively. A first power wire 41A and a second power wire 41B connect a first conduction strip 44A and a second conduction strip 44B to the power controller 4, respectively. Then, the first conduction strip 44A and the second conduction strip 44B are resiliently contacted with outer surfaces of the first conduction piece 26A and the second conduction piece 26B, respectively. Thus, the first conduction strip 44A and the second conduction strip 44B are electrically connected with the first conduction piece 26A and the second conduction piece 26B, respectively. Therefore, when the X-direction rotation shafts 23 are rotated, the power controller 4 can continuously supply power to the Y-direction motor speed governor 43.

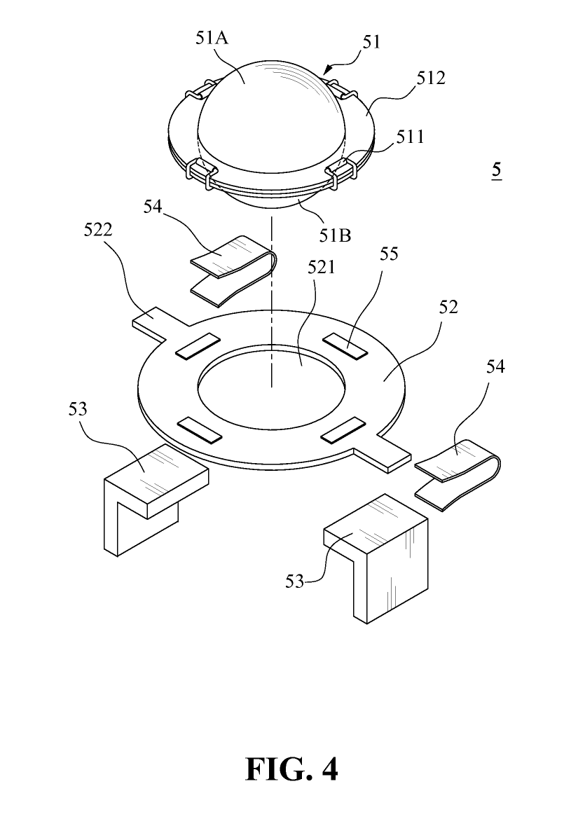

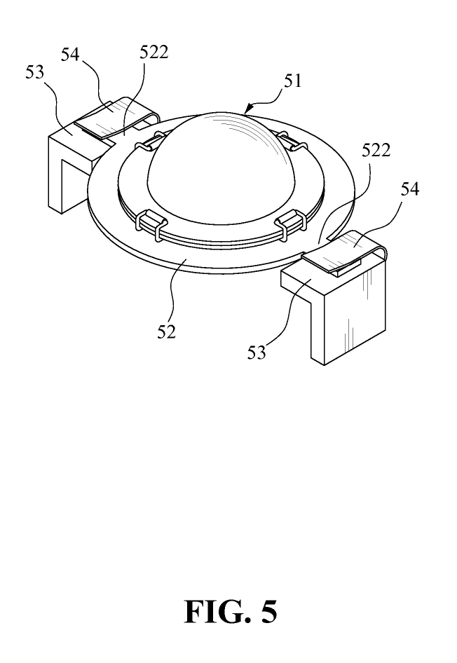

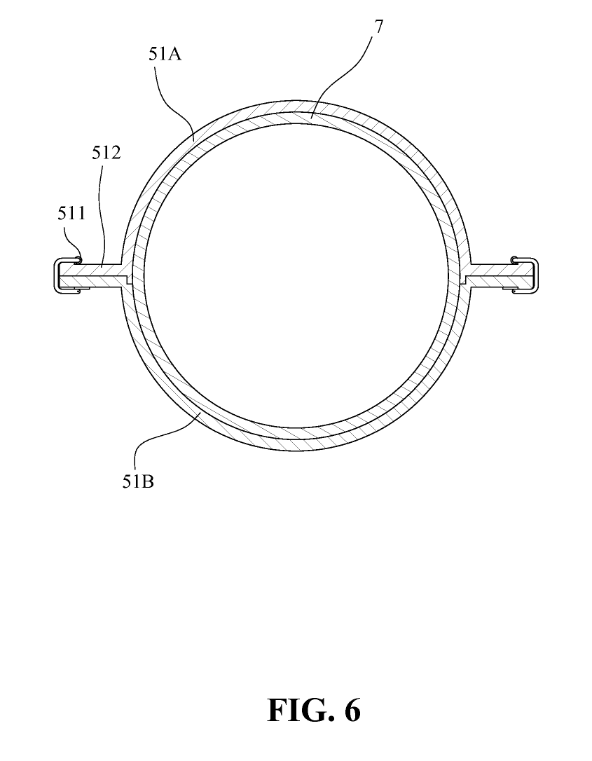

Referring to FIG. 4 to FIG. 6, the molding device 5 according to the present invention is disposed within the inner frame 35 and includes a mold 51. The mold 51 can be directly fastened to the inner frame 35. According to an embodiment, the molding device 5 may further include two supporting racks 53 disposed at two symmetrical inner sides of the inner frame 35 and a carrying plate 52 fastened on the supporting racks 53. The mold 51 is fastened on the carrying plate 52. The circular carrying plate 52 has a pair of ear portions 522 at two opposite ends thereof and a central hole 521 at the center thereof for receiving the mold 51. A plurality of magnets 55 is disposed on the periphery of the carrying plate 52 surrounding the central hole 521. The two ear portions 522 of the carrying plate 52 are disposed on the supporting racks 53, and then the ear portions 522 and the supporting racks 53 are clamped and fixed by U-shaped resilient clips 54, as shown in FIG. 5. When replacing a carrying plate having a central hole with different size, the resilient clips 54 are removed and then clamped again after the replacement is done. The mold 51 includes a top mold 51A and a bottom mold 51B. The periphery of the bottom mold 51B has a plurality of metal buckling units 511. When the top mold 51A and the bottom mold 51B are engaged, flanges 512 of the top and bottom molds 51A, 51B are fastened by the buckling units 511 for firmly engaging the top and bottom molds 51A, 51B. When the mold 51 is disposed in the central hole 521 of the carrying plate 52, the flanges 512 of the mold 51 are disposed on the periphery of the carrying plate 52 surrounding the central hole 521, and the buckling units 511 are attracted and fastened by the magnets 55. Thus, the mold 51 can be driven by the outer frame 29 and the inner frame 35 to perform continuous two-axial rotation until the PU material 7 is uniformly distributed over the inner surface of the mold cavity, as shown in FIG. 6.

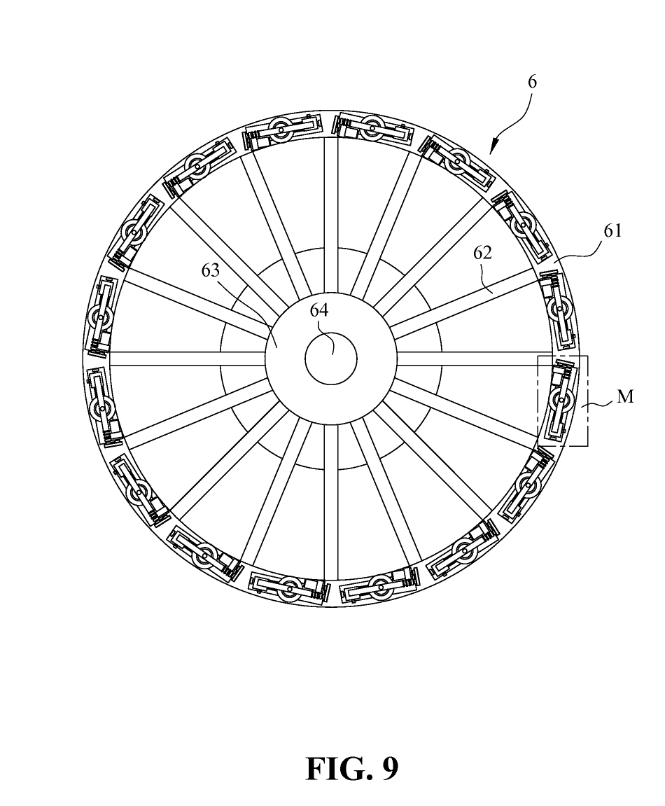

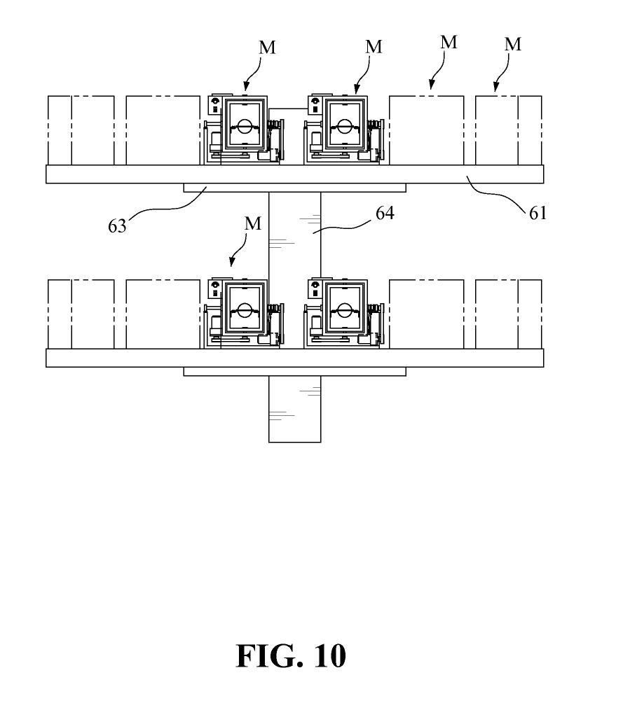

The aforementioned embodiments are a single machine M for manufacturing a hollow elastic ball. Referring to FIG. 9 and FIG. 10, for increasing the productivity, an apparatus for manufacturing a hollow elastic ball according to another embodiment of the present invention includes a rotation device 6 and a plurality of the machines M for manufacturing a hollow elastic ball installed on the rotation device 6. The rotation device 6 includes a vertical main shaft 64, a rotation plate 63 connected with the main shaft 64, an annular carrier 61 and a plurality of radial ribs 62 extended from the rotation plate 63 to the annular carrier 61. Referring to FIG. 9, the machines M for manufacturing a hollow elastic ball are mounted on the annular carrier 61. As shown in FIG. 10, a plurality of the annular carriers 61 may be mounted along the main shaft 64 and disposed at different heights thereof. The machines M for manufacturing a hollow elastic ball are installed on the annular carriers 61, and the main shaft 64 is driven to rotate by a motor (not shown) so as to drive the annular carriers 61 to rotate. The rotation speed of the annular carrier 61 can be adjusted depending on the solidifying rate of the PU material in the mold 51. Thus, when the mold 51 disposed on the annular carrier 61 is conveyed from a first location to a second location, the PU material 7 is solidified and is ready to be removed from the mold 51. Therefore, labor cost is reduced.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A machine for manufacturing a hollow elastic ball, comprising:
a base;
an X-direction driving device including an X-direction motor and an outer frame having an X-direction rotation shaft, the X-direction rotation shaft rotatably connected with the base, the X-direction rotation shaft driven to rotate by the X-direction motor and the outer frame driven to rotate about the X-direction rotation shaft;
a Y-direction driving device including a Y-direction motor and an inner frame having a Y-direction rotation shaft, the inner frame rotatably installed within the outer frame, the Y-direction rotation shaft driven to rotate by the Y-direction motor and the inner frame driven to rotate about the Y-direction rotation shaft; and
a molding device fastened in the inner frame.

2. The machine according to claim 1, wherein the machine further comprise an X-direction transmission mechanism having an X-direction active pulley connecting with the X-direction motor, an X-direction passive pulley connecting with the X-direction rotation shaft and a belt connecting the X-direction active pulley and the X-direction passive pulley.

3. The machine according to claim 1, wherein the machine further comprise a Y-direction transmission mechanism having a Y-direction active pulley connecting with the Y-direction motor, a Y-direction passive pulley connecting with the Y-direction rotation shaft and a belt connecting the Y-direction active pulley and the Y-direction passive pulley.

4. The machine according to claim 1, wherein the X-direction motor is mounted on the base and the Y-direction motor is mounted on the outer frame.

5. The machine according to claim 1, wherein a Y-direction motor speed governor is mounted on the outer frame and electrically connected to the Y-direction motor;
a power controller is mounted on the base; an X-direction motor speed governor is mounted on the base and electrically connected to the X-direction motor; the power controller supplies power to the X-direction motor speed governor and the Y-direction motor speed governor for controlling operations and rotation speeds of the X-direction motor and the Y-direction motor.

6. The machine according to claim 5, wherein the X-direction rotation shaft comprises a first conduction piece and a second conduction piece insulated to each other and rotating with the X-direction rotation shaft; the Y-direction motor speed governor is electrically connected to the first conduction piece and the second conduction piece by a first conduction wire and a second conduction wire, respectively; the power controller is electrically connected to a first conduction strip and a second conduction strip by a first power wire and a second power wire, respectively; then the first conduction strip and the second conduction strip are electrically contacted with the first conduction piece and the second conduction piece, respectively.

7. The machine according to claim 1, wherein the molding device comprises a carrying plate having magnets disposed on the carrying plate and a mold having objects capable of being attracted and fastened with the magnets.

8. The machine according to claim 7, wherein the mold comprises a top mold and a bottom mold, the object capable of being attracted and fastened with the magnet is a buckling unit that fastens the top mold with the bottom mold.

9. The machine according to claim 7, wherein the carrying plate comprises a central hole allowing the mold to be disposed therein.

10. The machine according to claim 7, wherein a supporting rack is installed on the inner frame and a plurality of fastening units fastens the carrying plate with the supporting rack.

11. The machine according to claim 10, wherein the fastening unit comprises a U-shaped resilient clip.

12. The machine according to claim 1, further comprising a supporting rack installed on the inner frame, a carrying plate fastened with the supporting rack, and a mold fastened with the carrying plate.

13. The machine according to claim 1, wherein the machine further comprise an X-direction transmission mechanism having an X-direction active gear connecting with the X-direction motor and an X-direction passive gear connecting with the X-direction rotation shaft, the X-direction active gear is engaged with the X-direction passive gear.

14. The machine according to claim 1, wherein the machine further comprise a Y-direction transmission mechanism having a Y-direction active gear connecting with the Y-direction motor and a Y-direction passive gear connecting with the Y-direction rotation shaft, the Y-direction active gear is engaged with the Y-direction passive gear.

15. An apparatus for manufacturing a hollow elastic ball, comprising:
a plurality of machines for manufacturing a hollow elastic ball, each of the machines having:
a base;
an X-direction driving device including an X-direction motor and an outer frame having an X-direction rotation shaft, the X-direction rotation shaft rotatably connected with the base, the X-direction rotation shaft driven to rotate by the X-direction motor and the outer frame driven to rotate about the X-direction rotation shaft;
a Y-direction driving device including a Y-direction motor and an inner frame having a Y-direction rotation shaft, the inner frame rotatably installed within the outer frame, the Y-direction rotation shaft driven to rotate by the Y-direction motor and the inner frame driven to rotate about the Y-direction rotation shaft; and
a molding device fastened in the inner frame; and
a rotation device including an annular carrier capable of being driven to rotate;
wherein the machines are installed on the annular carrier.

16. The apparatus according to claim 15, wherein the rotation device comprises a vertical main shaft having a rotation plate and the rotation plate is connected to the annular carrier by a plurality of ribs.

17. The apparatus according to claim 16, wherein a plurality of the annular carriers is installed along the main shaft at different heights.

18. The machine according to claim 15, wherein each machine further comprise an X-direction transmission mechanism that has an X-direction active pulley connecting with the X-direction motor, an X-direction passive pulley connecting with the X-direction rotation shaft and a belt connecting the X-direction active pulley and the X-direction passive pulley and a Y-direction transmission mechanism that has a Y-direction active pulley connecting with the Y-direction motor, a Y-direction passive pulley connecting with the Y-direction rotation shaft and a belt connecting the Y-direction active pulley and the Y-direction passive pulley.

19. The machine according to claim 15, wherein each machine further comprise an X-direction transmission mechanism that has an X-direction active gear connecting with the X-direction motor and an X-direction passive gear connecting with the X-direction rotation shaft and a Y-direction transmission mechanism that has a Y-direction active gear connecting with the Y-direction motor and a Y-direction passive gear connecting with the Y-direction rotation shaft; the X-direction active gear and the Y-direction active gear are engaged with the X-direction passive gear and the Y-direction passive gear, respectively.
